(19) United States
(12) Patent Application Publication
(10) Pub. No.: US 2023/0266166 A1
(43) Pub. Date: Aug. 24, 2023

(54) PULSE SPECTROSCOPY DEVICE

(71) Applicant: Ushio Denki Kabushiki Kaisha, Chiyoda-ku, Tokyo (JP)

(72) Inventor: Toshikazu NAGASHIMA, Chiyoda-ku, Tokyo (JP)

(73) Assignee: Ushio Denki Kabushiki Kaisha, Chiyoda-ku, Tokyo (JP)

(21) Appl. No.: 18/043,591

(22) PCT Filed: Aug. 5, 2021
(86) PCT No.: PCT/JP2021/029068

§ 371 Date: Mar. 1, 2023

(30) Foreign Application Priority Data
Sep. 2, 2020 (JP) 2020-147906

(51) Int. Cl. G01J 3/10; G02B 6/04; G02F 1/365

(52) U.S. Cl. CPC G01J 3/108; G02B 6/04; G02F 1/365

(57) ABSTRACT

The disclosure is to provide a practical structure of a pulse spectrometer that transmits pulsed light by dividing it through a plurality of fibers for pulse stretching, and makes the divided light beams overlap in a same region on an irradiation surface. A broadband pulsed light from a pulse light source is divided according to wavelength by an arrayed waveguide grating used as a dividing element, the pulse is then correlated one-to-one between time and wavelength while being transmitted through a bundle fiber, and then emitted through an irradiation unit onto an object. The individual light beams output from the individual cores of the bundle fiber are overlapped by a first lens in a substantially same region on a first plane perpendicular to an optical axis, and an image in the first region is projected by second lenses so as to be emitted on the object.

### BACKGROUND

### 1. Technical Field

The invention of this application relates to a technique for spectrometry making use of correspondence between time and wavelength of pulsed light.

### 2. Description of the Related Art

Pulsed oscillation laser (pulsed laser) is a typical pulse light source. In recent years, extensive studies have been made on stretching wavelength band of pulsed laser, which is typically exemplified by super continuum light (referred to as SC light, hereinafter) making use of a nonlinear optical effect. The SC light is a light obtained by allowing the light from the pulse laser source to pass through a nonlinear element such as fiber, so as to widen the wavelength band by a nonlinear optical effect such as self-phase modulation or optical soliton.

The aforementioned broadband pulsed light, although largely stretched in terms of wavelength range, has a pulse width (time width) that still remains close to the pulse width of an input pulse used to generate the SC light. Use of group delay in a transmission element such as fiber can, however, also stretch the pulse width. The pulse may be stretched while keeping one-to-one correspondence between time in the pulse (elapsed time) and wavelength, by selecting an element with suitable wavelength dispersion characteristic.

Such correspondence between time and wavelength in the thus stretched pulsed light (referred to as broadband stretched pulsed light) is effectively applicable to spectrometry. In a case where the broadband extended pulsed light is received by a certain photodetector, temporal change of light intensity detected by the photodetector corresponds to the light intensity at each wavelength, that is, a spectrum. The temporal change of output data from the photodetector may therefore be converted to a spectrum, thus enabling spectrometry without using a special dispersive element such as diffraction grating. That is, it now becomes possible to know a spectral characteristic (for example, spectral transmittance) of an object, by irradiating the object with the broadband stretched pulsed light, receiving light from the object with the photodetector, and measuring the temporal change thereof.

The broadband stretched pulsed light is thus considered to be particularly beneficial, typically in the field of spectrometry. It has, however, been found that the one-to-one correspondence between time and wavelength (referred to as time-wavelength correspondence, hereinafter) would collapse due to unintended occurrence of nonlinear optical effect, when the output of the pulse light source is enhanced to output light with higher energy. The collapse of time-wavelength correspondence would result in significant decrease of measurement accuracy, especially when applied to spectrometry.

For solution to this issue, an effective structure is that a plurality of fibers are used as a stretching element, so as to reduce the energy of transmitted light per fiber, thereby avoiding occurrence of the unintended nonlinear optical effect. Such transmission through the plurality of fibers to establish the time-wavelength correspondence, however, make patterns of the irradiated light misaligned on an irradiation surface. Both of multicore fiber and bundle fiber, which are possible structures to establish the time-wavelength correspondence with use of the plurality of fibers, would result in misaligned patterns of light output from the individual cores on the irradiation surface, rather than totally overlapped.

Irradiation of light with thus misaligned patterns will create an uneven irradiation characteristic within a region, in which the peripheral part free of overlapping of the patterns will be irradiated under conditions different from those for the center part. In particular, in a structure in which the light is transmitted through the fibers after being divided according to the wavelength, the irradiation region will have varied wavelength components from place to place, due to different wavelengths output through the individual fibers (or the individual cores), unfortunately resulting in that even the same object yields different measurement results (degraded accuracy), if the position of placement deviates.

Such problem has not been widely known. This is because the fiber having a plurality of cores, such as multicore fiber or bundle fiber, has been developed for communication as known in space division multiplexing, and has not been used for the uniformly irradiating a certain region with light typically for spectrometry. Hence, also a technical problem regarding overlapped irradiation in the same region has not been known.

### SUMMARY

The invention of the present application has been made to solve this problem, and an object of which is to provide a pulse spectrometer that achieves time-wavelength correspondence by transmitting pulsed light after being divided with a plurality of fibers, thereby making the light beams overlap in a same region on an irradiation surface, so as to prevent the measurement accuracy from degrading due to misalignment of the irradiation patterns.

Aimed at solving the aforementioned problem, a pulse spectrometer of the present application includes: a pulse light source; a multicore fiber or a bundle fiber that transmits divided pulsed light beams divided from a pulsed light beam emitted from the pulse light source. Each of the divided pulsed light beams output from the multicore fiber or from the bundle fiber follows a one-to-one correspondence between time and wavelength. The pulse spectrometer further includes the photodetector structured to detect light from an object irradiated with the divided pulsed light beams.

In the pulse spectrometer,
there are, arranged on an output side of the multicore fiber or the bundle fiber,
a first lens system that includes one or a plurality of lenses structured to make the divided pulsed light beams output from the individual cores of the multicore fiber or the cores of the bundle fiber overlap in a substantially same region on a plane perpendicular to an optical axis; and
a second lens system that includes one or a plurality of lenses structured to project an image in the substantially same region onto an irradiation surface.

In the pulse spectrometer, the second lens system may include a plurality of lenses capable of adjusting a projection magnification on the irradiation surface.

In the pulse spectrometer, the first lens system may be a lens system that converts the individual divided pulsed light beams output from the individual cores of the multicore fiber or the cores of the bundle fiber to parallel light beams, so as to make the parallel light beams overlap in the substantially same region.

Aimed at solving the aforementioned problem, an irradiation unit for multifiber according to the present application is a unit connected to an output side of the multifiber, which is a multicore fiber or a bundle fiber. The unit includes: a first lens system that includes one or a plurality of lenses structured to make light beams output from the cores of the multicore fiber or the cores of the bundle fiber overlap in a substantially same region on a plane perpendicular to an optical axis; and a second lens system including one or a plurality of lenses structured to project an image in the substantially same region onto an irradiation surface.

In the irradiation unit for multifiber, the second lens system may be a lens system that includes a plurality of lenses capable of adjusting a projection magnification on the irradiation surface.

In the irradiation unit for multifiber, the first lens system may be a lens system structured to convert the divided pulsed light beams output from the cores of the multicore fiber or the cores of the bundle fiber to parallel light beams respectively, so as to make the parallel light beams overlap in the substantially same region.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a schematic drawing of a pulse spectrometer according to an embodiment.

FIGS. 2A, 2B and 2C are schematic drawings illustrating creation of time-wavelength correspondence based on group delay.

FIG. 3 is a schematic plan view of an arrayed waveguide grating used as a dividing element.

FIG. 4 is a schematic drawing of an irradiation unit of a pulse spectrometer according to an embodiment.

FIG. 5 is a schematic drawing illustrating a structure of an irradiation unit of a reference example.

FIG. 6 is a chart schematically illustrating a main part of an exemplary measurement program product installed in the pulse spectrometer.

FIGS. 7A, 7B, 7C and 7D are schematic plan views illustrating an influence of positional deviation of an object.

### DESCRIPTION OF EMBODIMENTS

Next, modes for carrying out the invention (embodiments) of the present application will be explained.

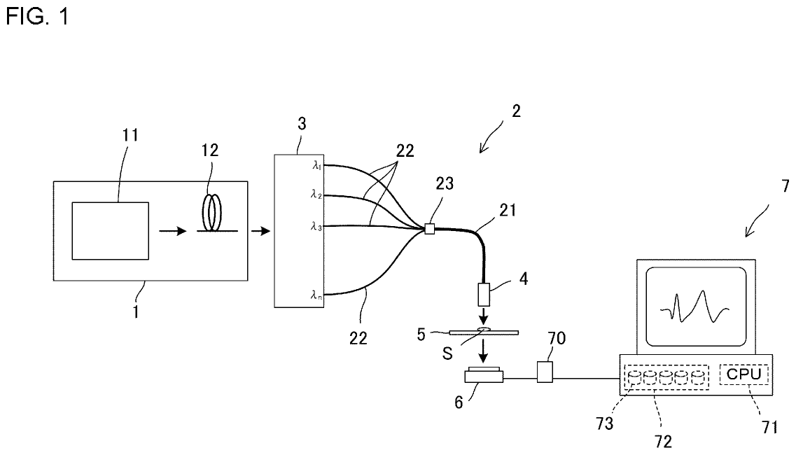

FIG. 1 is a schematic drawing of a pulse spectrometer according to an embodiment. The pulse spectrometer illustrated in FIG. 1 has a pulse light source 1, and a correlation unit 2 that establishes time-wavelength correspondence for pulsed light from the pulse light source 1, thus intended for spectrometry making use of the time-wavelength correspondence.

The pulse light source 1 is a light source that emits pulsed light having a continuous spectrum. In this embodiment, the light source typically emits light having a spectrum continuous over a wavelength width of at least 10 nm, in the range from 900 nm to 1300 nm. The “spectrum continuous over a wavelength width of at least 10 nm, in the range from 900 nm to 1300 nm” herein relates to a continuous wavelength width of 10 nm or larger, elsewhere in the range from 900 to 1300 nm. For example, the spectrum may be continuous from 900 to 910 nm, or from 990 to 1000 nm. Note that the spectrum is more preferably continuous over a wavelength width of 50 nm or larger, which is even more preferably 100 nm or larger. In addition, “the spectrum is continuous” means that the spectrum is continuous over a certain wavelength width. This is not limited to the case where the continuity covers the entire spectral range of the pulsed light, instead allowing partial continuity.

The reason for specifying the range from 900 nm to 1300 nm is that the pulse spectrometer is mainly intended for use in emission spectrometry in the near-infrared range. The light, having a spectrum continuous over a wavelength width of at least 10 nm, is typically SC light. In this embodiment, the pulse light source 1 is therefore given by an SC light source. A broadband pulse light source other than the SC light source may, however, be used in some cases.

The pulse light source 1, which is the SC light source, has an ultrashort pulse laser 11 and a nonlinear element 12. The ultrashort pulse laser 11 usable here includes gain-switched laser, microchip laser, and fiber laser. The nonlinear element 12 used most often is fiber. For example, photonic crystal fiber or other non-linear fiber may be used as the nonlinear element 12. Although many of the fiber have single mode, those having multimode may be used as the nonlinear element 12, as long as they can demonstrate sufficient nonlinearity.

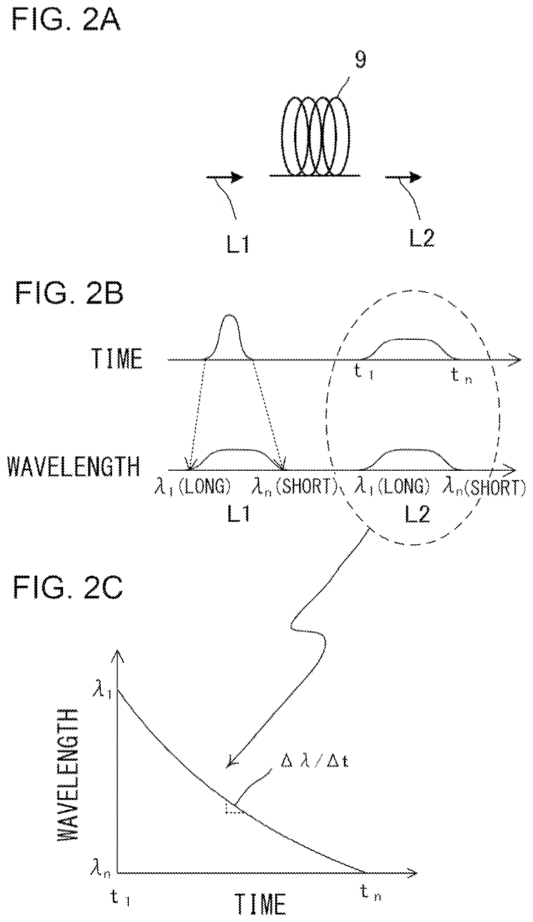

The correlation unit 2 is a unit that establishes the one-to-one correlation between time and wavelength as described previously. This will be explained with reference to FIGS. 2A-2C. FIGS. 2A-2C are a schematic drawing illustrating creation of the one-to-one correspondence between time and wavelength based on group delay.

SC light L1 having a continuous spectrum in a certain wavelength range will have a pulse width effectively stretched after passed through a group delay fiber 9 having a positive dispersion characteristic in such wavelength range. As illustrated in FIG. 2A, the SC light L1, although being an ultrashort pulse, contains light component with the longest wavelength λ₁ appeared in the early period of one pulse, light component with the wavelength gradually shortening appeared with the lapse of time, and light component with the shortest wavelength λₙ appeared in the last period of the pulse. Since light having shorter wavelength propagates with larger delay in the normal-dispersion group delay fiber 9, so that the light allowed to pass through such normal-dispersion group delay fiber 9 will have stretched time difference within one pulse as illustrated in FIG. 2B, and upon output from the fiber 9, the shorter wavelength light is further delayed behind the longer wavelength light. Hence, as illustrated in FIG. 2C, output SC light L2 will have a stretched pulse width, while keeping time-to-wavelength uniqueness. That is, the pulse is stretched while keeping the one-to-one correspondence between time t₁ to tₙ with wavelengths λ₁ to λₙ, respectively.

Note that the group delay fiber 9 for pulse stretching usable here may alternatively be an anomalous dispersion fiber. In this case, since the SC light disperses in such a way that the longer wavelength light component having appeared in the early period of the pulse delays, meanwhile the shorter wavelength light component having appeared in the later period advances, so that the temporal relationship in one pulse is inverted to give a pulse stretched in such a way that the shorter wavelength light component appears in the early period of the pulse, meanwhile the longer wavelength light component appears with the lapse of time. Most of such case may, however, require longer distance of propagation for pulse stretching as compared with the case of normal dispersion, and tends to increase the loss. In this aspect, the normal dispersion is preferred.

The pulse spectrometer of the embodiment employs a structure aimed at creating the time-wavelength correspondence, in which light is divided and transmitted through a plurality of fibers, typically with the length of the individual fibers optimized, rather than employing a structure making use of group delay in a single fiber as described previously. This is to suppress any unintended nonlinear optical effect in the fiber.

Establishment of the time-wavelength correspondence based on the divisional transmission through the plurality of fibers was found from the research by the present inventors. The research by the present inventors revealed that a high absorption object S, when analyzed by absorption spectrometry by irradiating it with light and dispersing the transmitted light, needs strong light to be emitted, thus needing high-intensity light with time-wavelength correspondence. In some other cases, the object S may need to be irradiated with strong light, from the viewpoint of enhancing S/N of the measurement, or speed-up of the measurement.

In order to irradiate the object S with the light having created the time-wavelength correspondence at high illuminance, a broadband pulsed light needs to be input to the group delay fiber at high intensity, and the pulse needs to be stretched while maintaining the high intensity. It has, however, been revealed that input of the high-intensity broadband pulsed light to the group delay fiber unfortunately causes an unintended nonlinear optical effect, which decays the time-to-wavelength uniqueness. Based on the finding, the embodiment now employs a structure that creates the time-wavelength correspondence by divisional transmission through the plurality of fibers.

The plurality of fibers in this embodiment are given by a bundle fiber 21. On the input side of the bundle fiber 21, there is provided a dividing element that divides light to be input to the individual fibers (referred to as element fibers, hereinafter) that constitute the bundle fiber 21. The dividing element employs an element that divides light according to wavelength, which is an array waveguide grating (AWG) 3 in this embodiment.

In a case where the bundle fiber 21 is used as the group delay element, a possible structure is such that the light from the pulse light source 1 is simply divided into a plurality of light beams to be input to the individual fibers, to cause the group delay. Although such structure would suffice, this embodiment employs a dividing element that divides light according to the wavelength, in order to cause wavelength-dependent amount of group delay. As this type of dividing element, this embodiment employs the arrayed waveguide grating 3.

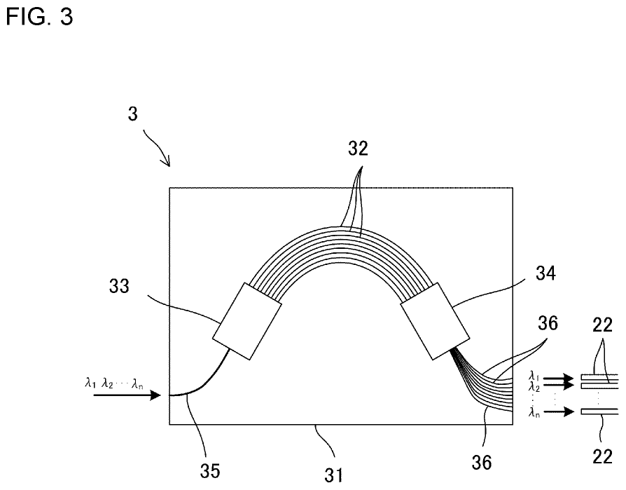

FIG. 3 is a schematic plan view of an arrayed waveguide grating used as the dividing element. The arrayed waveguide grating is an element developed for optical communication, and has not been known for use in spectrometry. As illustrated in FIG. 3, the arrayed waveguide grating 3 is structured by forming the individual functional waveguides 32 to 36 on a substrate 31. The functional waveguides include a large number of grating waveguides 32 having slightly varied optical path lengths, slab waveguides 33 and 34 connected to both ends (input side and output side) of the grating waveguides 32, an input-side waveguide 35 through which the light is input to the input-side slab waveguide 33, and output-side waveguides 36 that extract light of the individual wavelengths from the output-side slab waveguide 34.

The slab waveguides 33 and 34 form free spaces. The light beam input through the input-side waveguide 35 spreads in the input-side slab waveguide 33, and enters the individual grating waveguides 32 while keeping the same phase. Since the individual grating waveguides 32 have slightly varied lengths, so that the light beams reached the ends of the individual grating waveguides 32 will have the phases slightly varied (shifted) corresponding to the difference. The light beams are output from the individual grating waveguides 32 while being diffracted. The diffracted light beams pass through the output-side slab waveguide 34 while mutually interfering, and reach the input side of the output-side waveguides 36. The interfered light beams in this timing will have the highest intensities at positions corresponded to the wavelengths, due to the phase shift. That is, the individual output-side waveguides 36 will receive input of light beams with successively different wavelengths, thus spatially dispersing the light. In a strict sense, the individual output-side waveguides 36 are formed so that the individual input ends thereof are located to cause such dispersion of light.

The individual element fibers of the bundle fiber 21 are connected via relay fibers 22 to the individual output-side waveguides 36. The individual relay fibers 22 and the individual element fibers are coupled by a connector element 23 such as a fan-in/fan-out device. Hence, the pulsed light beams divided according to the wavelength are transmitted via the relay fibers 22 through the individual element fibers, during which delay occurs corresponding to the wavelength. That is, difference in the length of the relay fibers 22, varied depending on the wavelength, causes difference in the transmission time varied among the wavelengths. Upon overlapping (multiplexing) of the light beams output from the individual element fibers on the object S, there is created an event in which the light with the one-to-one correspondence between time and wavelength is emitted, similarly to the case of pulse stretching.

The pulse spectrometer has an irradiation unit 4 as illustrated in FIG. 1, aiming at irradiating the object S with the light having the time-wavelength correspondence as described previously. The irradiation unit 4 is a unit arranged on the output side of the bundle fiber 21.

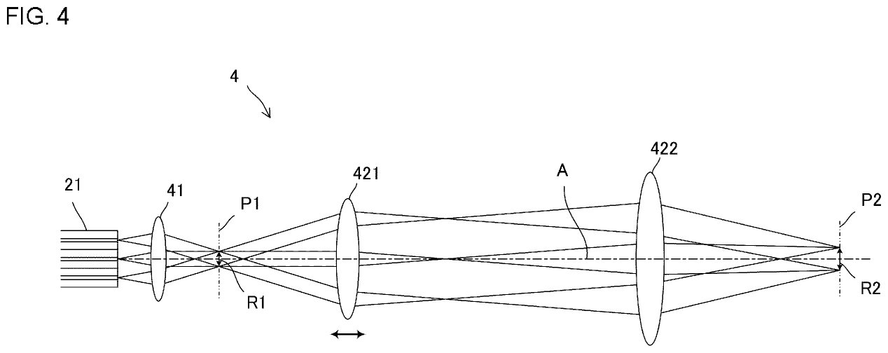

FIG. 4 is a schematic drawing of the irradiation unit of the pulse spectrometer according to the embodiment. The irradiation unit 4 is a unit that makes the light beams output from the individual element fibers emitted on an irradiation surface, while being overlapped in the substantially same region. As illustrated in FIG. 4, the irradiation unit 4 has a first lens and second lenses 41, 421, 422, and an unillustrated housing that houses these lenses 41, 421, 422.

The first lens 41 is a lens that makes the light beams output from the cores of the individual element fibers overlap in a substantially same first region on a plane perpendicular to the optical axis (indicated by A, in FIG. 4). The optical axis A herein means an optical axis on the output end face of the bundle fiber 21. More precisely, a line that lies at the overall center of the bundle fiber 21, perpendicular to the end face, represents the optical axis A. Since the bundle fiber 21 is usually constituted by bundling a plurality of element fibers in a center-symmetrical manner, so that the center thereof is understood to be the overall center of the entire bundle fiber 21. If the arrangement is not center-symmetrical, the center is defined by the center of an area surrounded by an envelope of the end faces of the fibers that constitute the bundle (the center of gravity of the region that is assumed to be a homogeneous plate).

In FIG. 4, the first region is denoted by R1. A plane to which the first region R1 belongs is denoted by P1. As illustrated in FIG. 4, the first region R1 is a small region located close to the output end face of the bundle fiber 21. Note that, as illustrated in FIG. 4, the first lens 41 in this embodiment is given as a lens that collimates the light beams, spread and output from the cores of the individual element fibers, to be emitted on the first region R1.

The second lens 421, 422 are lenses that project an image of the first region R1 onto a second region. In FIG. 4, the second region is denoted by R2. A plane to which the second region R2 belongs (a plane perpendicular to the optical axis A) is denoted by P2. The second lenses 421, 422 are two lenses. Of the two second lenses, the lens 421 arranged closer to the output end face of the bundle fiber 21 is referred to as a front lens, and the lens 422 arranged on the far side is referred to as a rear lens.

The front lens 421 is a lens for adjusting the magnification of the image in the first region R1. Hence, there is provided a mechanism that holds the front lens 421 so as to be movable along the optical axis, just like in a zoom lens. The rear lens 422 is a lens that condense the light in the second region R2. The magnification, although suitably selectable, is typically set within the range approximately from 0.5× to 3×.

As can be seen in FIG. 4, the distance up to the first region R1 is short. The distance measures approximately 4 to 10 mm. Conversely, over such short distance, only one lens will suffice to overlap irradiation patterns of the light beams from the individual element fibers within the substantially same region. However in a case where a long distance for irradiation is desired for some reason, the irradiation patterns cannot be overlapped within the substantially same region, since there is no lens having suitable focal length. Overlapping by condensation rather than collimation, although feasible with use of lens of long focal length, will not occur substantially in the same region.

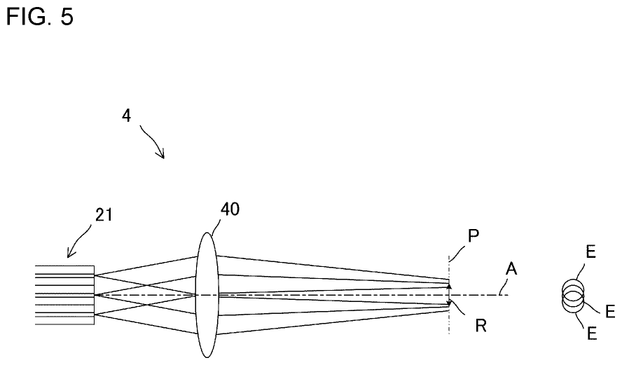

FIG. 5 is a schematic drawing regarding this point, illustrating a structure of an irradiation unit of a reference example. The reference example is structured to condense, and then project, light beams output from a multicore fiber 81 having three cores, with use of a condenser lens 40 having a focal length of approximately 50 mm. The output ends of the three cores are arranged vertically in the drawing.

The right hand side of FIG. 5 illustrates irradiation patterns E of the light beams output from the three cores. As illustrated herein, the light beams output from the individual cores do not overlap in the substantially same region R on a plane P, but are emitted with misalignment.

In contrast, the embodiment uses the first lens 41 so as to make the irradiation patterns overlap in the first region R1, and uses the second lenses to project the image in the region R1 onto the second region R2, thus making it possible to obtain the irradiation patterns overlapped substantially in the same region R2 as illustrated in FIG. 4, even over a long distance of irradiation. Exemplary dimensions are approximately 1 to 3 mm in diameter for the first region R1, and 2 to 4 mm for the second region R2.

Note that “substantially”, stated in the phrase “substantially the same region”, means an extent to which the misalignment of the irradiation patterns will not pose a practical problem. For example, circular irradiation patterns may be regarded as “substantially the same”, if the distance of misalignment is not larger than 10% of the diameter. Non-circular patterns may be regarded as “substantially the same”, if the misalignment is not larger than 10% of the width observed in a direction and at a position where the patterns look the longest.

Note that the first lens 41 given as a lens that collimates (parallelizes) the light beams to be overlapped in the first region R1 is beneficial in terms of facilitating adjustment of the projection magnification with the front lens 421. With the first lens 41 given as the collimator lens, the light beams overlapped in the first region R1, which tend to separate again to advance in different directions, can reach the front lens 421, while keeping the beam diameter substantially unchanged. The diameter of the light beams that reach the front lens 421 remain unchanged, even if the front lens 421 is moved along the optical axis for adjusting the magnification. This simplifies design of the front lens 421 and the rear lens 422.

In such irradiation unit 4, a filter is appropriately provided in an unillustrated housing, or at an opening on the output side of the housing. The filter may be a neutral density filter, or a wavelength selective filter such as band pass filter or cut filter. Position of provision in the housing may be anywhere, such as between the front lens 421 and the rear lens 422, or on the output side of the rear lens 422.

The apparatus of the embodiment has a holding member that holds the object S at a position (position of the second region R2) on which the pulsed light is emitted by the irradiation unit 4. In this embodiment structured to emit the pulsed light from the top, the holding member is given as a stage 5. Since the apparatus of this embodiment is aimed to analyze spectral transmission characteristic of the object S, so that the stage 5 is translucent, with a photodetector 6 arranged at a position where the transmitted light is received.

The apparatus is equipped with a calculation unit 7, as a unit for processing the output of the photodetector 6 to obtain results of spectrometry. The calculation unit 7 employed in this embodiment is a general-purpose PC. Between the photodetector 6 and the calculation unit 7, there is provided an AD converter 70, through which the output of the photodetector 6 is input to the calculation unit 7.

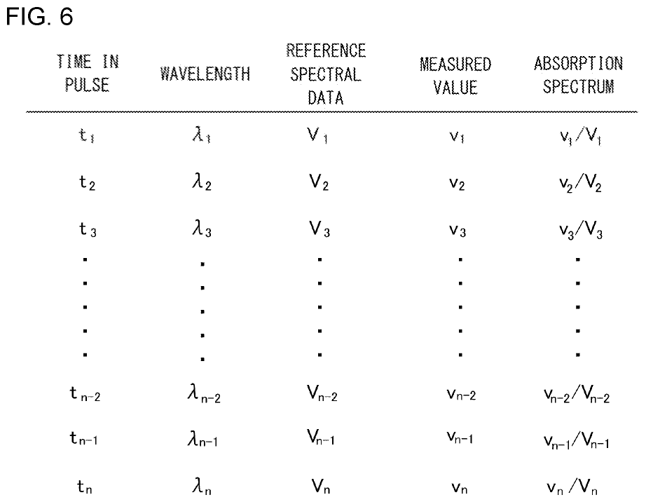

The calculation unit 7 has a processor 71, and a storage unit (hard disk, memory, etc.) 72. The storage unit 72 has installed therein a measurement program product 73 for processing output data from the photodetector 6 and calculating the spectrum, and other necessary program products. FIG. 6 is a chart schematically illustrating a main part of an exemplary measurement program product installed in the pulse spectrometer.

FIG. 6 illustrates an exemplary case where the measurement program product 73 analyzes an absorption spectrum (spectral absorption rate). The absorption spectrum is calculated with use of reference spectral data. The reference spectral data contains values for the individual wavelengths, which serve as reference for calculating the absorption spectrum. The reference spectral data is acquired by making the light from the irradiation unit 4 incident on the photodetector 6, without passage through the object S. That is, the light is made directly incident on the photodetector 6 without passage through the object S, and the output of the photodetector 6 is input to the calculation unit 7 via the AD converter 70, to acquire values at a time resolution Δt. The individual values are stored as reference intensities (V₁, V₂, V₃, . . . ) at the individual time points (t₁, t₂, t₃, . . . ) at intervals of Δt. The time resolution Δt is a quantity determined by response speed (signal putout cycle) of the photodetector 6, and means a time interval at which a signal is output.

The reference intensities V₁, V₂, V₃, . . . at the times t₁, t₂, t₃, . . . represent intensities (spectra) of the corresponding wavelengths λ₁, λ₂, λ₃, . . . . Since the times t₁, t₂, t₃, . . . in one pulse have already been correlated with the wavelengths, so that the values V₁, V₂, V₃, . . . at the individual times are handled as the values at λ₁, λ₂, λ₃, . . . .

Upon irradiation of the photodetector 6 with the light, having passed through the object S, the output of the photodetector 6 passes through the AD converter 70, and is similarly stored in the memory as values (measured values) (v₁, v₂, v₃, . . . ) at the individual times t₁, t₂, t₃, . . . . The individual measured values are compared with the reference spectral data (v₁/V₁, v₂/V₂, v₃/V₃, . . . ), and the results are given in the form of absorption spectrum (expressed in logarithm scale of the inverse, as necessary). The measurement program product 73 has been programmed to execute such arithmetic processing.

Next, operations of the pulse spectrometer will be explained.

When starting the spectrometry with use of the pulse spectrometer of the embodiment, first, the pulse light source 1 is turned on without placing the object S. The broadband pulsed light from the pulse light source 1 is divided by the arrayed waveguide grating 3 as the dividing element, and transmitted through the individual relay fibers 22, and further through the individual element fibers of the bundle fiber 21. The transmitted light is output from the irradiation unit 4 while keeping the time-wavelength correspondence, and reaches the photodetector 6. The output data from the photodetector 6 is processed, to preliminarily acquire the reference spectral data.

Next, the object S is placed on the stage 5, and the pulse light source 1 is turned on again. The pulsed light is similarly divided while keeping the time-wavelength correspondence, and is emitted through the irradiation unit 4 onto the object S. The light transmitted through the object S reaches the photodetector 6, and output data from the photodetector 6 is input through the AD converter 70 to the calculation unit 7. The absorption spectrum is then calculated by the measurement program product 73.

In this operation, the patterns of the light beams output from the individual element fibers are projected to the second region R2 where the object S resides, without being misaligned. Hence, the irradiation conditions will remain unchanged even if the object S causes some displacement, thus enabling highly reproducible spectrometry.

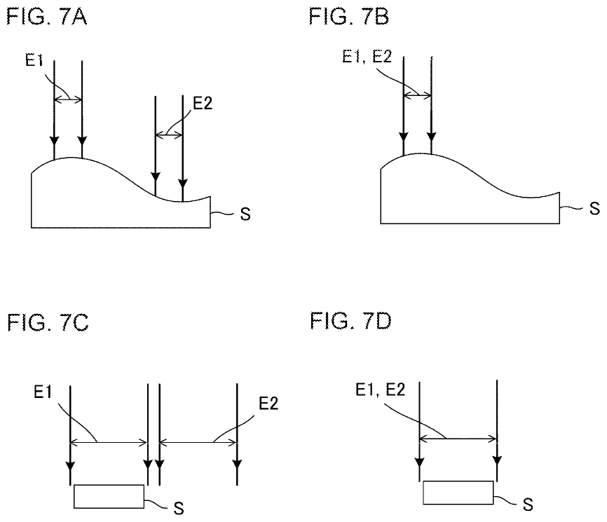

This will be further explained with reference to FIGS. 7A-7D. FIGS. 7A-7D are schematic plan views illustrating an influence of positional deviation of the object. FIGS. 7A and 7B illustrate cases where the irradiation pattern E1 and the irradiation pattern E2 are misaligned as the reference example in FIG. 5, meanwhile FIGS. 7C and 7D illustrate cases where the irradiation pattern E1 and the irradiation pattern E2 overlap in the same region as in the embodiment.

Dimensional relation between the irradiation region and the object S includes a case where the irradiation region is smaller than the object S, thus causing photoirradiation only on a certain range of the object S; and a case where the irradiation region is larger than the object S, thus causing photoirradiation over the entire range of the object S (the entire surface on the input side). FIGS. 7A and 7B illustrate the former case, and FIGS. 7C and 7D illustrate the latter case.

Assume now that, from among components contained in the object S, a component X is to be detected at the wavelength of light that gives the irradiation pattern E1, and a component Y is to be detected at the wavelength of light that gives the irradiation pattern E2. Assume now that the irradiation pattern E1 is given by the light with wavelength λ1, and the amount of the component X may be known from absorption rate of the light with wavelength λ1. Also assume now that the irradiation pattern E2 is given by the light with wavelength λ2, and the amount of the component Y may be known from absorption rate of the light with wavelength λ2.

Also assume now that, as illustrated in FIG. 7A, the object S has an irregularity, with the irradiation pattern E1 cast on a projection, and the irradiation pattern E2 cast on a recess. Both the irradiation patterns E1 and E2 are smaller than the object S. In this case, even if the object S contained the same amounts of the component X and the component Y, the contents of both the components X and Y will appear to be abundant on a cross section taken at the projection in the direction of travel of light, meanwhile the contents of both the components X and Y will appear to be scarce on a cross section taken at the recess. Hence, the component X detected with the light that gives the irradiation pattern E1 and passes through the projection will be detected to be abundant, whereas the component Y detected with the light that gives the irradiation pattern E2 and passes through the recess will be detected to be scarce. That is, a relative difference will emerge between the amounts of detection of the components X and Y.

With the irradiation pattern E1 and the irradiation pattern E2 thus misaligned, it is not possible to determine whether or not such relative difference is ascribable to difference in the position (thickness) of the object S, or to difference of the contents in the object.

In contrast, with the irradiation pattern E1 and the irradiation pattern E2 overlapped as illustrated FIG. 7B, the measured results of the contents of the components will not differ due to thickness, since the measurement takes place at the same position even if the object S had an irregularity. This enables highly accurate measurement.

In another case, as illustrated in FIG. 7C, where the irradiation patterns are larger than the object S, and the irradiation pattern E2 is not emitted on the object S, the component Y even if contained in the object S, is not detectable. In contrast, with the irradiation pattern E1 and the irradiation pattern E2 overlapped as illustrated in FIG. 7D, then both the component X and the component Y are detectable.

As can be seen from FIGS. 7A-7D, the reproducibility will not degrade even if the object S slightly deviates, if the irradiation patterns overlap substantially in the same region. Conversely, the object is not necessarily placed at the strictly same position, proving an advantage that the position of placement of the object S no longer requires high accuracy. This advantage is particularly beneficial in an application where products that flow (conveyed) on a manufacturing line are subjected to real-time spectrometry in which the pulsed light is emitted on the products for pass/fail judgment. For such application, the spectrometry is often conducted by irradiating, with the pulsed light, an irradiation region, through which the object S is allowed to travel in a non-stop manner, during which data is acquired from the photodetector 6 at the timing each object S passes through the irradiation region. Any deviation of timing in this case corresponds to deviation of the aforementioned position of placement. The structure of the embodiment, no longer in need of high accuracy of position of placement, proves its advantage that the reproducibility will not degrade even if the timing slightly deviates.

Also availability of long distance of irradiation proves a great benefit in various applications of spectrometry. For example, in a case where the object S during conveyance is irradiated with the pulsed light as described previously, the measurement is more likely to be affected by the accuracy of a conveyance mechanism, if the irradiation distance is short. That is, the object S, if conveyed while deviated in the direction of optical axis due to poor accuracy of the conveyance mechanism, would be more likely to accidentally collide on the irradiation unit 4. This requires a highly accurate conveying mechanism. If a long distance of irradiation is available, such highly accurate conveying mechanism is no longer necessary. This also applies to the case where the object S is kept stationary in the irradiation area.

In addition to the mechanical aspect, availability of long distance of irradiation can also provide a merit from the optical aspect. Although a short distance of irradiation would make it difficult to arrange the aforementioned filter, the embodiment can make the arrangement easy. Alternatively, some cases may need, for example, a mirror placed so as to change the direction of light in the middle for some reason. Also such cases may be easily coped with, according to the structure of the embodiment.

Note that, the first lens 41, and the second lenses 421, 422, each of which is illustrated as a single lens in FIG. 4, may occasionally be constituted by a plurality of lenses, typically for the purpose of removing chromatic aberration. In addition, each of the second lenses may occasionally be constituted by a single lens, rather than by two lenses which are the front lens 421 and the rear lens 422. In this case, the magnification may occasionally be changed typically with use of a revolver mechanism for exchanging the lenses. The distance of irradiation may also be varied by exchanging the rear lens 422 which determines the distance to a final projection surface.

In the embodiment, the individual relay fibers 22, and the individual element fibers in the bundle fiber 21 may be same fiber or different fibers, in terms of material and length. Even the same material can yield different amounts of group delay if the length is varied, thus allowing use of the element fibers with the length varied according to the wavelength. The same applies to the material. The spectrometry with more uniform Δλ/Δt value and uniform resolution (small variation of resolution depending on wavelength band) may be achieved, by selecting the length and material of the fiber so as to optimize the amount of group delay depending on wavelength. Since mutual adjustment of the material and length for the individual element fibers of the bundle fiber 21 are often labor-consuming, so that it is practical to adjust the material and length according to the wavelength, for the relay fiber 22.

There also may be a case where the multicore fiber is used as the group delay element. Also in a case with the multicore fiber, the irradiation unit 4 is structured to contain the first lens 41 that overlaps the light beams output from the individual cores in the substantially same first region, and the second lenses 421, 422 that project the image of the first region R1 onto the second region R2. A specific example of the multicore fiber, suitably used herein, is such as having a core diameter of approximately 100 to 150 μm, and the number of cores of approximately seven. The size of the first region R1 and the size of the second region R2 are almost equal to those in the case of the bundle fiber.

The number of cores of the multicore fiber is practically several to 10 or around, meanwhile the number of element fibers of the bundle fiber 21 may be larger, allowing use of a bundle fiber having several tens of element fibers bundled therein. Hence, the bundle fiber is preferred for the purpose of increasing the number of division of the dividing element. The number of division is increased possibly because the transmission power per core is reduced by increasing the number of cores, thereby further suppressing unintended nonlinear optical effect; and/or, because the amount of group delay is more finely adjustable by finer division for the case of wavelength-dependent division. In an exemplary case where the aforementioned arrayed waveguide grating is used as the dividing element, the number of division may be approximately 50 to 70, for which applicable is the bundle fiber having nearly equal number of element fibers bundled therein.

Other possible structures of the dividing element include those using a plurality of fiber couplers in multiple steps for division, or, using a plurality of dichroic mirrors in multiple steps for division.

While the aforementioned exemplary operations of the apparatus relate to the absorption spectrometry, other possible cases relate to measurement of spectral characteristics such as reflection spectrum (spectral reflectance) and internal scattered light.

Another possible structure may be such as using a plurality of ordinary fibers in parallel without being bundled, rather than using the multicore fiber or the bundle fiber. In this case, the irradiation unit 4 may be connected to the plurality of fibers, via a connector element such as a fine fan-out device.

Alternatively, the pulse spectrometer may be structured to acquire the reference spectrum in real time. A structure adoptable in this case is such as splitting the light output from the bundle fiber or the multicore fiber with use of a beam splitter into two beams, one of which is emitted on the object S, and the other is input to a reference photodetector. The reference photodetector receives the light beam that has not passed through the object S, and the output therefrom is similarly subjected to AD conversion to yield data, which is the reference spectral data. The beam splitter in this structure may be arranged inside the irradiation unit 4, or may be separately arranged on the output side of the irradiation unit 4.

Note, although the description above exemplified spectrometry of transmitted light from the object S, another possible case relates to spectrometry of reflected light from the object S, with use of the photodetector 6 arranged at a position where the reflected light from the object S is received. Still another possible case relates to spectrometry of scattered light or fluorescence, captured from the object S irradiated with light by the irradiation unit 4. That is, the light from the object S may typically be transmitted light, reflected light, fluorescence, or scattered light from the object S irradiated with light.

The pulse light source 1 adoptable here other than that emits SC light, may be amplified spontaneous emission (ASE) light source, superluminescent diode (SLD) light source, and so forth.

The aforementioned irradiation unit 4 is a unit arranged on the output side of the multicore fiber or the bundle fiber, and is therefore an irradiation unit for multifiber. The “multifiber” is a generic term for the multicore fiber and the bundle fiber. The irradiation unit for multifiber is not limited for use where the multifiber is used for creating the time-wavelength correspondence of the broadband pulsed light. The unit is suitably used in applications where light needs to be divisionally transmitted and overlapped on the irradiation surface, for some reason. Some bundle fiber may be bundled only at the output end, with the input end left unbundled.

What is claimed is:

1. A pulse spectrometer comprising:
a pulse light source;
a multicore fiber or a bundle fiber that transmits divided pulsed light beams divided from a pulsed light beam emitted from the pulse light source, wherein each of the divided pulsed light beams output from cores of the multicore fiber or from cores of the bundle fiber follow a one-to-one correspondence between time and wavelength; and
a photodetector structured to detect light from an object irradiated with the divided pulsed light beams,
wherein the pulse spectrometer further comprises, arranged on an output side of the multicore fiber or the bundle fiber,
a first lens system that includes one or a plurality of lenses structured to make the divided pulsed light beams output from the cores of the multicore fiber or the cores of the bundle fiber overlap in a substantially same region on a plane perpendicular to an optical axis; and
a second lens system that includes one or a plurality of lenses structured to project an image in the substantially same region onto an irradiation surface.

2. The pulse spectrometer according to claim 1, wherein the second lens system includes a plurality of lenses capable of adjusting a projection magnification on the irradiation surface.

3. The pulse spectrometer according to claim 2, wherein the first lens system is a lens system that converts the divided pulsed light beams output from the cores of the multicore fiber or the cores of the bundle fiber to parallel light beams respectively, so as to make the parallel light beams overlap in the substantially same region.

4. An irradiation unit for multifiber connected to an output side of a multifiber which is a multicore fiber or a bundle fiber, the irradiation unit for multifiber comprising:
a first lens system that includes one or a plurality of lenses structured to make light beams output from the cores of the multicore fiber or the cores of the bundle fiber overlap in a substantially same region on a plane perpendicular to an optical axis; and
a second lens system that includes one or a plurality of lenses structured to project an image in the substantially same region onto an irradiation surface.

5. The irradiation unit for multifiber according to claim 4, wherein the second lens system includes a plurality of lenses capable of adjusting a projection magnification on the irradiation surface.

6. The irradiation unit for multifiber according to claim 5, wherein the first lens system is a lens system structured to convert the divided pulsed light beams output from the cores of the multicore fiber or the cores of the bundle fiber to parallel light beams respectively, so as to make the parallel light beams overlap in the substantially same region.
